(19) United States
(12) Patent Application Publication
(10) Pub. No.: US 2014/0205986 A1
(43) Pub. Date: Jul. 24, 2014

(54) BRAIN BASED LEARNING METHOD

(71) Applicant: Srinivasan Pillay, Newton, MA (US)

(72) Inventor: Srinivasan Pillay, Newton, MA (US)

(21) Appl. No.: 13/746,238

(22) Filed: Jan. 21, 2013

(51) Int. Cl. G09B 7/00

(52) U.S. Cl. CPC G09B 7/00
USPC 434/335

(57) ABSTRACT

A brain research-based learning method is provided. The learning method begins by a user viewing a presentation that provides a quantity of information to the user. During the viewing, the user may answer a plurality of periodic prompts on a computer relating to the presentation. After the presentation, the user may answer a series of questions on a computer. Later, at periodic intervals after the presentation the user is provided a second series of questions to reinforce the learned information. In the event of an incorrectly answered question, the computer may provide an alert. Further, after the presentation, a long term memory storage activity may be performed by the user using a computer. Finally the learning progress of the user may be provided using the at least one computer.

### BACKGROUND OF THE INVENTION

1. Field of the Invention

The present invention relates generally to learning systems. More particularly the present invention relates to a learning system that takes advantage of how the brain learns to teach more effectively.

2. Description of Related Art

Employee training, learning, and development are a significant expenditure in the budgets of United States organizations. Further, there is substantial evidence that investment in human capital provides for sustainable and productive economic growth. However, merely throwing money at employee learning and development is not a productive answer. Instead, increases in efficiency will lead to better results and savings for the organization.

Recent trends in learning at leading companies include mobile learning as well as the utilization of developing technologies. Although both of these incur development costs, over the long term they have the potential to produce considerable savings due to content reuse and decreasing overall costs. Further, with the demands for agility within organizations increasing, self-paced learning is becoming increasingly important.

Most companies that have processes to manage their money do not have comparable processes to manage their leaders. Talent masters are leaders who place a premium on knowing and developing their high potential employees. Continuous learning and improvement is essential, but very few companies actually have systems in place to monitor this or help themselves grow. Yet, billions of dollars are blindly thrown at this all important issue.

Further, regarding worker productivity, learning, effectiveness, and health, “burnout” is a major problem at many work settings which results in a less effective work environment. Burnout is a very specific syndrome characterized by emotional exhaustion, depersonalization and reduced personal fulfillment (Burnout Syndrome and Weekly Workload of On-call Physicians: Cross Sectional Study, Barbosa, Leao et al. 2012; Development and Validation of a Measuring Instrument for Burnout Syndrome in Teachers, Rodriguez Mantilla and Fernandez Diaz 2012). Other prominent researchers define burnout as being primarily about exhaustion, cynicism and inefficacy due to chronic emotional and interpersonal stressors on the job (Job burnout, Maslach, On the Clinical Validity of the Maslach Burnout Inventory and the Burnout Measure, Schaufeli et al. 2001). Burnout is primarily characterized by work psychology. It is distinctly NOT a diagnosis by traditional classification systems such as DSM-V but ICD-10 considers it a significant factor representing major personal problems that have impact on health status and illness behavior (Burnout: illness or symptom?, Kapfhammer 2012).

Several instruments currently exist to measure exhaustion such as the Karolinska Exhaustion scale (Validation of Karolinska Exhaustion Scale: psychometric properties of a measure of exhaustion syndrome, Saboonchi, Perski et al. 2012) and The Maslach Burnout Inventory (MBI). The latter is based on a consistent body of research that shows that work overload, insufficient reward, community breakdown, conflicts in values, absence of fairness and lack of control are the six primary causes of burnout (Six areas of worklife: a model of the organizational context of burnout, Leiter and Job Burnout, Maslach 1999) and has been studied in a variety of contexts of the years (Depersonalised doctors: a cross-sectional study of 564 doctors, 760 consultations and 1876 patient reports in UK general practice, Orton, Orton et al. 2012; Burnout and effort-reward imbalance improvement for teachers by a manual-based group program, Unterbrink, Pfeifer et al. 2012; Concurrent validity of single-item measures of emotional exhaustion and depersonalization in burnout assessment, West, Dyrbye et al. 2012). Thus, burnout is a distinct and measurable syndrome when it is strictly correlated with work, and when the dimensions of emotional exhaustion, depersonalization, cynicism and reduced personal fulfillment are utilized.

Although the overall MBI is a useful and valid measure of burnout (Validity of the Maslach Burnout Inventory for family practice physicians, Rafferty, Lemkau et al. 1986; On the Clinical Validity of the Maslach Burnout Inventory and the Burnout Measure, Schaufeli, Bakker et al. 2001; The job related burnout questionnaire. A multinational pilot study, Yaman and Soler 2002), recent studies have shown that single items may correlate more with outcome. For example, one study of medical students, internal medicine residents, and practicing surgeons showed that relative to the full MBI, single-item measures of emotional exhaustion and depersonalization exhibit strong and consistent associations with key outcomes such as major medical errors and suicidality (Single item measures of emotional exhaustion and depersonalization are useful for assessing burnout in medical professionals, West, Dyrbye et al. 2009; Organizational determinants of work outcomes and quality care ratings among Army Medical Department registered nurses, Patrician, Shang et al. 2010; Concurrent validity of single-item measures of emotional exhaustion and depersonalization in burnout assessment, West, Dyrbye et al. 2012) Thus, there is room for improvement in understanding how specific measures correlate with outcomes. Furthermore, although there are valid diagnostic instruments, there are currently no instruments that allow for automated single-measure correlations, tracking and intervention all on one system.

Therefore, what is needed is a learning system that may provide efficient and effective training, as well as a system to measure the efficacy of such training with relation to various metrics. Further, what is needed is a device, or computer-operate system that may provide automated correlations, tracking, and intervention of burnout in an integrated system.

### SUMMARY OF THE INVENTION

The subject matter of this application may involve, in some cases, interrelated products, alternative solutions to a particular problem, and/or a plurality of different uses of a single system or article.

In one aspect, a learning method is provided. The learning method begins by a user viewing a presentation that provides a quantity of information to the user. During the viewing, the user may answer a plurality of periodic prompted questions on a computer relating to the presentation. This mimics reinforcement methods for remembering that the brain may ideally engage in, but often does not unless prompted. Along the presentation the presentation, the user may answer a series of questions on a computer. This is the next stage of making sure that information remains in the brain's short-term memory center. Later, at periodic intervals after the presentation, the user is provided a second series of questions to reinforce the learned information. This step is important in order to reinforce the “group of facts” and not simply “facts as they come” in short term memory. The brain may start to link the different facts that are learned here. In the event of an incorrectly answered question, the computer may provide an alert. This allows for early correction and storage of accurate information in short-term memory and prevents connection of wrong information with learned facts. Further, after the presentation, a long term memory storage activity may be performed by the user on a computer. This step collates an even bigger chunk of information that is sent from the brain's short-term memory to long-term memory. In this stage, users will be prompted to use techniques that will allow easier storage of “compressed files” in long-term memory. E.g. mnemonics and diagrams. Finally, the learning progress of the user may be provided using the computer. Here, feedback will be provided in brain terms-describing where along the reinforcement process learning may have been interrupted: immediate recall, short-term memory or long-term memory consolidation.

In another aspect, the learning method may further include analysis and presentation of the learning progress of the user. Initially, a baseline metric to be tracked over the course of a training program is determined. This baseline may be determined before the learning described above. This baseline metric may be determined by analysis of survey data and/or recorded productivity data. Further, the computer may grade the training modules with a relevance rating regarding the module and the desired or needed training. Based on this determined metric, a computer may be used to select a plurality of appropriate training modules for presentation to the user. This is a very specific return on investment technique which is referred to herein as “link-n-lock”—where the learning user records learning priorities that are then selected from available modules that are either created by the system's inventor or provided by other learning specialists. Once these models are chosen by the user based on desired dimensions such as changes in mood, organizational structure, financial goals and/or actions, changes in each of the required dimensions is tracked over time and linked to the learning of the user or users. Hence, the NBG link-n-lock method. After training, the metric may be re-determined, and the metric scores are compared and graphed over a period of time.

### BRIEF DESCRIPTION OF THE DRAWING

FIG. 1 provides a flow chart of an embodiment of the brain based learning method.

### DETAILED DESCRIPTION

The detailed description set forth below in connection with the appended drawing is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a brain based learning system that mimics brain operation to optimize learning. Further, the present invention concerns a system that tracks the learning system or other training's impact on varying metrics over time. The tracking system and learning system may be integrated to allow for the tracking of the learning system and its impact on important organizational metrics such as profits, employee attitude, and the like. Further, the systems may be computerized to optimize flexibility and effectiveness.

The brain based learning system may utilize learning strategies that take advantage of the way the human brain receives information, stores it in short term memory, stores it in long term memory, and then solidifies the information as a readily accessible “packet” of learned information.

Initially, the learning system may aid in storage of information within a user's short-term memory. The information received may be one or more of several types of presentation, such as a training module presentation, a brief “just before” refresher course, a half-hour presentation, a full-hour presentation, a half day presentation and a full day presentation, among others. In fact, one series of modules represents 5 minutes of integrated learning using a videotaped narrative, voice-over with a slideshow presentation and a movie-clip—to stimulate multimodal learning which in turn increase neuroplasticity (the ability of the brain to change) in adults. Further, in varying embodiments, the separate presentations may be in the form of a slideshow, movie, live speaker, audio file, reading assignment, computerized presentation, and the like.

In one embodiment, to aid in storage of information within a user's short term memory, the presentation may feature frequent prompts to solidify the short term memory coding of the learned information as described above. In another embodiment, a prompt may be a question about the material. In another embodiment, a prompt may be a query about if the user is paying attention (attention has to be optimized in the brain in order for memory to also be accurate.) In still another embodiment, the prompt may be a combination of attention queries and material based (very short-term memory or immediate recall) questions, and may vary throughout the presentation. These prompts preferably may be provided at short intervals such as once every minute, two minutes or the like. In a further embodiment, the prompts may be provided at varying intervals to keep a user focused and “on their toes.” These prompts may be provided using a computer, and/or may be integrated into the presentation.

To further solidify short-term memory retention (after the stage of helping immediate recall), the system may provide a series of questions to a user immediately after the completion of the presentation. These questions may determine if, and to what extent, the presented information has been coded into the short-term memory of the user, and further aid in solidifying the information in the short-term memory of the user. In one embodiment, the series of questions may be presented using a computer.

Once information is stored in the short-term memory of the user, it is vital that the information be shifted to long term memory in order to allow the user to retain the learned information. The present system may utilize a series of cued recall techniques, as well as questions about the material over an extended time period. (Diagrams, mnemonics, music and movies may help to register information in long-term memory.)

In one embodiment, a user is instructed to perform a follow up activity shortly after the presentation. This follow up activity may occur immediately after the presentation, within hours of the presentation, or within days of the presentation. The timing may depend on user preference, type of follow up activity and/or type of material presented.

Examples of follow up activities may include, but are not limited to: filling out a diagram, filling out a form, creating and memorizing a mnemonic, or creating and memorizing a song, among others. Further, these activities may be carried out using a computer. The idea here is that the “door” to long-term memory can only be opened by information that is filed without taking up too much space in the brain (compressed by mnemonics) or that which is emotionally significant such as when the information is associated with a favorite song (the brain hold onto such information longer.)

In a further embodiment, after the presentation an email (or similar) prompt may be sent to the user using a computer interface. The email prompt may comprise questions regarding the material that a user must answer correctly. If a question is not answered correctly, corrective action may be taken. Examples of corrective action may include requiring review, re-taking a portion or all of a presentation, a correct answer and explanation of the answer, a notice being automatically sent to a supervisor using a computer, and the like.

The timing of the prompts may vary, and may be sent to the user in any periodic manner that is suitable to reinforce learned information. In one embodiment, the prompts may be sent daily for one week after the presentation, then monthly for six months after the presentation, then once every three months after six months, and yearly after two years from the presentation. This process may be automated using a computer.

After the above noted embodiments are implemented, the goal is for the user to have stored the information permanently in their long-term memory as a “packet,” allowing for quick and easy retrieval of the information on cue.

The learning system may further comprise a series of optional activities to enhance long-term memory storage. In one embodiment, an optional activity may be connecting with a learning community—either in person, through a telephone conference call, or online using a computer and online interface via a message board, interactive interface, chat, video chat, or social networking environment.

In another embodiment, an optional activity may be to play a user's favorite music during the prompts or follow up activities to aid in cementing the learned knowledge.

In still another embodiment, an optional activity may include follow up reading on a subject related to the presentation topic.

In yet another embodiment, an optional activity may be for a user to provide constructive feedback to the presentation providers. This constructive feedback may be provided by any means. For example, the constructive feedback may be a letter, email, interactive message board posting, telephone conference, and the like.

The learning system may further comprise a peer-to-peer learning interface. The peer-to-peer interface may integrate with the optional activity and/or prompt phase of the learning system. The peer-to-peer interface may be accessed using a computer, thereby allowing peers to interact remotely. This system may allow a user to ask and answer questions as well as directly communicate with others taking the same or similar training courses and presentations.

Throughout the steps of the learning system, a user may be prompted to interact virtually with brain-based graphics to enhance learning by the interaction and carefully constructed graphics designed to facilitate learning and development. In one embodiment, these graphics may be presented to the user using a computer.

As part of the learning system, the user may be required to participate in development tracking. In one embodiment, this tracking may include filling out surveys during and/or after the presentation and learning system is performed.

Further, an organization may require users to fulfill a determined or standardized training requirement. In one embodiment, the training requirement may be a number, and each presentation may be assigned a certain number. After each presentation, a user may subtract the number assigned to the presentation from the training requirement number to determine how much training must be performed to reach the training requirement.

The learning system contemplated herein may be integrated with a training tracking system to allow an organization to track the effects of trainings, and to see progress from a pre-training baseline to goals set by the organization.

The learning system may be integrated with the training tracking system, and the baseline and organizational goals. The learning system may then be configured to automatically determine what presentations and presentation groups may be appropriate based on the goals. Moreover, the learning system may be configured to display a rating for various presentations that will indicate the most relevant teaching presentations, allowing for a customized presentation package.

The training tracking system may further be configured to provide a graphical output to display the progress of various organizational metrics over time. The origin of the graph will be at the time training begins on the x axis, and the baseline of the metrics before training on the y axis. At a top of the y axis are the goals of the organization. Updates to the graph may be made periodically and be based on organizational statistics such as profits; revenue, billed work and the like, as well as calculated metrics based on survey responses and observed behavioral changes of employees who are involved in the learning system. These metrics may be individualized, or may be an average of a group. Data may be gathered and recorded by the organization itself, or by a third party consultant. By providing the graphical output, an organization can track how the learning system results in productivity increases, revenue increases, and return on investment.

The types of metrics measured by the graphical output may vary greatly, and be determined based on any needs or goals of a company. In one embodiment, the different metrics may be evaluated on a scale of one to ten to provide an easily trackable numbered system.

One example of a metric tracked by the training tracking system may be employee state of mind. The “State of Mind” metric may be calculated based on employee reports or observation on issues such as anxiety, stress, attention/focus levels (poor, medium, good), openness to change or lack thereof, ability or difficulty cementing new habits, management of uncertainty, burnout, prejudice, creative mindset or lack thereof, and the like. The state of mind data may be gathered through observation, survey, and the like. Once this data is acquired, it may be compared to baselines, industry standard data, or data from competing organizations. The data may also be converted to a one to ten value, ten being good, one being bad. Once the value is assigned, a goal value can be determined, and input into the training tracking system. The learning system may then identify, based on the state of mind metric value, what are the most appropriate training programs to achieve the goal value.

Another example of a metric tracked by the training tracking system may be behavior change. The “Behavior Change” metric may be calculated based on employee reports or observation regarding undesirable behaviors such as procrastination, poor communication, risk aversion, addiction to the status quo, non-collective thinking, prejudiced behavior, volatility, and the like.

A further example of a metric tracked by the training tracking system may be organizational/structural change. The “Organizational/Structural Change” metric may be calculated based on employee reports or observation regarding organizational and structural aspects of the workplace that could be improved. Examples of negative structural and organizational aspects may include poor teamwork, reticence to creating a leaner organization, reticence to creating a necessarily agile organization, poor top down alignment, undeveloped sales pipeline, poor innovation, slow product cycles, and the like.

Another example of a metric tracked by the training tracking system may be profits. The “Profits” metric may measure various financial values such as revenue, profit, billed hours, invoice collection rate, and the like.

In a further embodiment, the learning system may be integrated with an online database of available speakers, experts, related literature and/or related trainings. This integration may allow organization directors to access the database to schedule speakers and the like. Further, the integration may allow a training user to access related literature and trainings to enhance their knowledge.

In yet another embodiment, the learning system modules may be open sourced, and may allow an expert in the field of the learning module to enter data, adjust the module, edit the module, create a new module, and the like.

The system may further comprise a mobile application or other computerized application that provides coaching using particular modules. This application may allow users to be coached remotely, on the go, and using any number of computing platforms, thereby increasing training opportunity to users. The application may be integrated with the remainder of the system and aid in a user's development, development tracking, and goal achievement. A user may log into the application with a login and password. Once logged in, the user may choose from a series of packaged modules, such as the modules described herein. Within each module is at least one sub-module of packaged information. A user may select which sub-module to view and what content to view. Each sub-module may contain any combination of a narrative, slide show, workbook, pre-assessment, post-assessment, general assessment, and ability to send (via email or the like) an assessment or narrative to a coach. As such a user may be able to use the coaching application to fulfill training goals. In a further embodiment, a coach may be able to self-coach using the application in the same way that a user may be coached.

One particular module, which may be used on the application specifically, or by the system generally, may be a sales prep module. The sales prep module may allow a user to review basic brain-based principles of sales prior to a sale, sales meeting, pitch, and the like. It may prepare and coach sales leaders on which types of empathy to use (cognitive vs. emotional), how to use loss aversion techniques to stimulate reconsideration of a purchase, and the like.

In still another embodiment, the learning system may be integrated with a system configured to measure burnout of organization employees. The burnout measuring system may comprise a series of survey questions to measure burnout and its various stages. Further, the burnout measuring system may provide early intervention guidance to prevent employees from becoming burnt out. The early intervention guidance may vary depending on the answers to the survey questions and the type of burnout and stage of burnout the user is experiencing. The burnout measuring system may be integrated into a computer interface, and optionally a mobile computing device interface such as a computer, laptop, smart phone, tablet or other mobile computing device. The burnout measuring system utilizes a series of questions to determine what stage of burnout a person is at, and provide an overall burnout level, or score. These stages have been created by the inventor whose specialty is anxiety and burnout. The system then determines which of the six (prior research-based) major causes of burnout is most responsible for the burnout (work overload, absence of fairness, community breakdown, lack of control, insufficient reward or conflicting values) and also provides original cause-linked suggestions for overcoming burnout. Furthermore, the system also provides tools from the inventors and other approved experts that help to decrease burnout. The burnout level of the user may be recorded and tracked over time. In addition, the burnout assessment portion of this system helps learners address obstructions to learning earlier on, so that they may correct the burnout earlier on rather than later prior to investing in learning. Users will also be able to compare their own scores with chosen others in the community, within and across organizations, among demographics within a user's professional field, and the like.

Burnout is not the same as depression, anxiety, or exhaustion. In fact, it is proven to be very different, in both its causes, along with the physical and emotional results.

Symptoms may cluster in different ways for different individuals. For example, individuals with a major depressive disorder typically have depressed mood, poor sleep and appetite, decreased interest in day-to-day activities, prominent guilt feelings, decreased energy and concentration, and suicidal ideas, plans or actions (Diagnostic and statistical manual of mental disorders, (4th ed., text rev.), Association 2000). While at first glance, this syndrome may seem very similar to burnout, it differs in several respects: 1. It is not exclusively connected to job circumstances; 2. It does not include the criterion of cynicism; 3. The validity of scales that measure depression, cluster very different factors (not ineffectiveness, exhaustion and cynicism) and often depression and burnout scales are used to be able to pick-up the differences (Survey of the prevalence of burnout, stress, depression, and the use of supports by medical students at one school, Chang, Eddins-Folensbee et al. 2012); 4. Often stress-related exhaustion precedes depression and early detection is important (Course of mental symptoms in patients with stress-related exhaustion: does sex or age make a difference? Glise, Ahlborg et al. 2012)—in fact, stress-related exhaustion and burnout may predict anxiety and depression (Perceived medical school stress and the development of behavior and experience patterns in German medical students, Voltmer, Kotter et al. 2012); 5. Some neuroendocrine findings show that burnout is likely a distinct syndrome—the higher the burnout the lower the cortisol. Burnout likely leads to hypofunction of the hypothalamic-pituitary axis which is a characteristic of exhaustion and not depression (Neuro-endocrine correlates of burnout, Verhaeghe, Van Den Eede et al. 2012). Also, on EEG studies, burnout subjects differ from subjects with depression or chronic fatigue by having reduced P300 amplitude, a lower alpha peak frequency and reduced beta power (EEG findings in burnout patients, van Luijtelaar, Verbraak et al. 2010). Another hormone, BDNF has also been associated with burnout but not depression (The role of BDNF and HPA axis in the neurobiology of burnout syndrome, Onen Sertoz, Tolga Binbay et al. 2008) and immunity be also associated with work-related stress (The HPA-axis and immune function in burnout, Mommersteeg, Heijnen et al. 2008). The inconsistencies in some of the biological findings is partly due to the fact that burnout and depression may overlap (in all likelihood, burnout may predispose one to develop depression) but they are clearly not identical (The impact of burnout on human physiology and on operational performance: a prospective study of soldiers enrolled in the combat diver qualification course, Morgan, Cho et al. 2002; Physiological differences between burnout patients and healthy controls: blood pressure, heart rate, and cortisol responses, De Vente, Olff et al. 2003; Do burned-out and work-engaged employees differ in the functioning of the hypothalamic-pituitary-adrenal axis, Langelaan, Bakker et al. 2006; Clinical burnout is not reflected in the cortisol awakening response, the day-curve or the response to a low-dose dexamethasone suppression test, Mommersteeg, Heijnen et al. 2006; Burnout and functioning of the hypothalamus-pituitary-adrenal axis—there are no simple answers, Sonnentag 2006; The HPA-axis and immune function in burnout, Mommersteeg, Heijnen et al. 2008). Also, the markers for inflammation appear to be different in burnout, depression and anxiety (The association between burnout, depression, anxiety, and inflammation biomarkers: C-reactive protein and fibrinogen in men and women, Toker, Shirom et al. 2005).

Numerous studies point to the fact that burnout is not simply the same as “vital exhaustion” in that it typically includes exhaustion but also other dimensions such as personal ineffectiveness and cynicism as well. Most likely, exhaustion leads to the full burnout syndrome (Cortisol in burnout and vital exhaustion: an overview, Kudielka, Bellingrath et al. 2006; Professional burnout and stress among Polish physicians explained by the Hobfoll resources theory, Glebocka and Lisowska 2007; Type D personality in the general population: a systematic review of health status, mechanisms of disease, and work-related problems, Mols and Denollet 2010).

Examination of DSM-IV TR also shows that anxiety syndromes are vastly different from the burnout syndrome (Diagnostic and statistical manual of mental disorders, (4th ed., text rev.), Association 2000), in that panic, PTSD and OCD are obviously clustered differently. Depersonalization disorder is also a relatively circumscribed illness without exhaustion or inefficacy included in the symptoms. The only anxiety disorder which overlaps with both major depression and burnout is generalized anxiety disorder where the symptoms are excessive worry, restlessness, being easily fatigued, difficulty concentrating, irritability, insomnia, blankness of mind and muscle tension. But the overlap with depression is more striking that with burnout as the criteria for burnout are more specific in including cynicism, personal ineffectiveness and depersonalization. Still, most investigators would recognize that these are three distinct syndromes which may overlap in symptoms and predispose to each other, or even co-exist (much the way that diabetes and hypertension might with each other or heart disease even though they are vastly different with overlapping pathophysiologic mechanisms (Generalized anxiety and C-reactive protein levels: a prospective, longitudinal analysis, Copeland, Shanahan et al. 2012), (Psychological distress, depression, anxiety, and burnout among international humanitarian aid workers: a longitudinal study, Lopes Cardozo, Gotway Crawford et al. 2012).

The tables below summarize the distinctions between depression, anxiety and burnout as well as the relatively unique elements of the present burnout measuring system.

TABLE 1
Differences Between Burnout, Depression and
Generalized Anxiety Disorder (GAD)

| | Depression | GAD | Burnout |
|---|---|---|---|
| 1 | Typically have | Typically have | Typically have |
| | depressed mood, | excessive worry, | emotional |
| | poor sleep and | restlessness, | exhaustion, |
| | appetite, | being easily | cynicism, |
| | decreased | fatigued, | depersonalization |
| | interest in day- | difficulty | and reduced |
| | to-day | concentrating, | personal |
| | activities, | irritability, | fulfillment |
| | prominent guilt | insomnia, | |
| | feelings, | blankness of mind | |
| | decreased energy | and muscle | |
| | and | tension. | |
| | concentration, | | |
| | and suicidal | | |
| | ideas, plans or | | |
| | actions | | |
| 2 | Not exclusively | Not exclusively | Exclusively job |
| | job related | job related | related |
| 3 | Measured by HAM- | Measured by GAD-7 | Measured by MBI |
| | D or BDI | | |
| 4 | It does not | It does not | Includes the |
| | include the | include the | criterion of |
| | criterion of | criterion of | cynicism |
| | cynicism | cynicism | |
| 5 | Associated with | No association | Associated with |
| | hyperfunction of | with hypothalamic- | hypofunction of |
| | the | pituitary axis | the hypothalamic- |
| | hypothalamic- | | pituitary axis |
| | pituitary axis | | |
| 6 | Delayed p300 | Normal p 300 | Reduced P300 |
| | latency, ad | latency and | amplitude, a |
| | reduced p300 | magnitude; more | lower alpha peak |
| | amplitude, but | left than right | frequency and |
| | greater beta | hemisphere low and | reduced beta |
| | power especially | high beta activity | power on EEG |
| | during sleep | | |
| 7 | No association | No association | Reduced BDNF |
| | with reduced | with BDNF | |
| | BDNF in a | | |
| | comparative | | |
| | study | | |
| 8 | Markers for | Markers for | Markers for |
| | inflammation are | inflammation are | inflammation are |
| | different | different | different |

TABLE 2
Unique Elements of Burnout Measuring System vs.
Existing Technologies

| | | Existing (Online) |
|---|---|---|
| | Burnout mate | Technologies |
| 1 | Based on most robust | No robust online |
| | burnout scales | measurement tool |
| 2 | Only integrated | No integrated system of |
| | assessment of symptoms, | burnout management exists |
| | stages, causes and | |
| | recommendations | |
| 3 | Connects to world | Does not to world experts |
| | experts who offer | who offer advice from |
| | advice from respected | forums or websites |
| | forums and websites for | |
| | instant coaching | |
| 4 | Connects people to an | No integrated tool that |
| | online community | connects people to an |
| | | online community |
| 5 | Allows for statistical | No integrated tool that |
| | comparisons across | allows for statistical |
| | multiple demographics | comparisons across |
| | in the general | multiple demographics in |
| | population | the general population |
| 6 | Allows for statistical | No integrated tool that |
| | comparisons across | allows for statistical |
| | multiple demographics | comparisons across |
| | within and across | multiple demographics |
| | corporations | within and across |
| | | corporations |
| 7 | Connected to learning | No integrated tool that |
| | modules based on | is connected to learning |
| | neuroscience-based | modules based on |
| | interventions | neuroscience-based |
| | | interventions |
| 8 | Allows for single | No integrated tool allows |
| | factor correlations | for single factor |
| | with outcomes | correlations with |
| | | outcomes |
| 9 | Data and validity being | No integrated tool has |
| | constantly checked - | data and validity being |
| | connected to graduate | constantly checked |
| | school programs on | |
| | statistics | |
| 10 | Allows for additional | No integrated tool that |
| | tools that link with | allows for additional |
| | burnout mate to be used | tools that link with |
| | | burnout mate to be used |

The brain based learning system may further comprise a sales pitch training system and method that utilizes on brain-based science. The sales pitch training system may be integrated into a computerized application and may allow a user using a computer to record a sales pitch, have the pitch reviewed and shared, provide automatic feedback on the pitch coupled with the brain science behind the feedback, provide suggestions on how to make the pitch better, and provide automatic pitch generation based on user input.

The system may provide a login option for a user to log into the system and access saved information and personalized interfaces. Further, the system may be configured to record a pitch from the user, using a video or audio recorder in communication with the computer. Once finished, the recorded pitch may be reviewed, and shared. Sharing may be with specific experts for review, with a peer-review online forum, friends, personal contacts, the general public, and the like. This sharing may be through email, website posting, remote server posting, and the like.

The system may provide a structured approach for a reviewer to review, assess, and critique a sales pitch provided to them. In one embodiment, the system may provide an interface to evaluate the pitch at short time intervals such as minute by minute assessment, every five minutes, or the like. In a particular embodiment, the system may provide a reviewer with a standardized rating scale that may rank the reviewer's opinion at each time interval. An example of the standardized scale may be selection of the following: Captivating, Small improvements needed, So-so, Boring, and I have completely lost interest. In a further embodiment, each rating may be given a point value descending from 5 to 1. As such, a pitch's score may be given a number value at time intervals over the time length of the pitch, as well as an overall score.

In another embodiment, the system may provide the reviewer with prompts to provide additional feedback such as attention prompts indicating a reviewer's feelings and attention during the pitch. In one embodiment the prompts may be given throughout the pitch recording. In another embodiment, the prompt may be given after the pitch.

Examples of prompts to provide additional feedback may include attention prompts to select “what best describes a pitch”: Too much detail—too soon too fast; Too vague or fuzzy; There is no frame to provide context; Too similar to other pitches; Seems needy; and Going too slow. Each of these exemplary selections may be used to automatically analyze the pitch and provide suggestions for how to improve the pitch, and used by the system to create an attention score indicating the reviewer's attention level through the pitch.

When a reviewer selects the “too much detail—too soon too fast” option it indicates that the user has overwhelmed the reviewer with details regarding the pitch. This can lead to a less effective pitch. The system may then automatically provide ways to identify if their pitch has too much detail, and provide ways to save the pitch. Examples of how to identify if an audience feels that there is an overly detailed pitch include: Eyes glazing over, restlessness, pens being tapped, and phones being checked. The system may suggest that the pitch may be saved by the user saying something like “Now I know you're getting restless” or asking a question to bring the audience's attention back.

When a reviewer selects the “too vague/fuzzy” option, it indicates that the user is losing credibility with the audience because their pitch is too vague, causing the audience to lose confidence. The system may provide ways to identify if an audience believes the pitch is too vague such as: People scratch their heads; people start to look irritated or angry, people start to look tired; and people get distracted. The system may suggest that the pitch may be saved by the user saying something like “Let me give you an example . . . ” or “Up until now this may have sounded vague . . . ” or “It is hard to imagine why this could be the case but . . . ”

When a reviewer selects the “No Frame to Provide Context” option, it indicates that the user has not answered the “so-what” question by not giving context to their statements. Lack of context causes the reviewer's brain to activate its conflict center, putting the reviewer on edge. The system may provide ways to identify if an audience believes the pitch lacks context such as: the audience looks confused, anxious, distracted, and like he or she does not “get it”. The system may suggest that the pitch may be saved by the user going back and retracing their steps, and/or explicitly stating the value of what was previously said.

When a reviewer selects the “Too similar to other pitches” option, it indicates that the user's pitch is too similar to other pitches and not unique, causing the audience to lose interest. The system may provide ways to identify if an audience believes the pitch is too similar to others such as: the audience looks disinterested, looks unfocused, they are talking to others, and they display an immediate or early-on disconnect. The system may suggest that the pitch may be saved by the user directly addressing that the pitch is not “just another” pitch.

When a reviewer selects the “You seem needy” option, it indicates that the user is making their audience feel nervous, desperate, and/or unconfident. The system may provide ways to identify if an audience believes the user seems needy such as: the audience looks uncomfortable, awkward, or defensive about not being able to satisfy the user. The system may suggest that the pitch be saved by the user stating their desire to work with the audience, stating their comfort and confidence in their pitch, and displaying passion.

When a reviewer selects the “Going too slow” option, it indicates that the user is moving too slowly, and losing the interest of the audience. The system may provide ways to identify if an audience believes the user is moving too slowly. The system may then suggest that the pitch be saved by the user picking up his or her pace.

It should be understood that at varying times during the pitch, a reviewer may provide different selections regarding their attention prompts. As such, a user may receive a “No frame to provide context” feedback at one point in the pitch, and a “Too much detail” feedback later in the pitch.

Further, the system may provide brain-based explanations of reviewer feedback and prompt answers to explain to a user what is happening to the reviewer, and why. This brain-based feedback better helps the user understand the root issues, and how to make the best pitch possible.

Once the reviewer finishes assessing the sales pitch, the system may automatically compile the reviewer's assessment and provide suggestions for how to improve the pitch, along with optional comments from the reviewer. Next, a report may be sent directly to the user who created the pitch providing the feedback and assessment generated by the system.

In another embodiment, the sales pitch training system may provide a structured interface to allow a user to answer certain questions, and with those answers, automatically create a pitch paragraph for the user. The pitch paragraph may extract content from the user's answers, as well as filler content to join the extracted content into a coherent paragraph. This may be performed by the system receiving a user's input in response to questions, calculating the inputs and providing a paragraph of prose output.

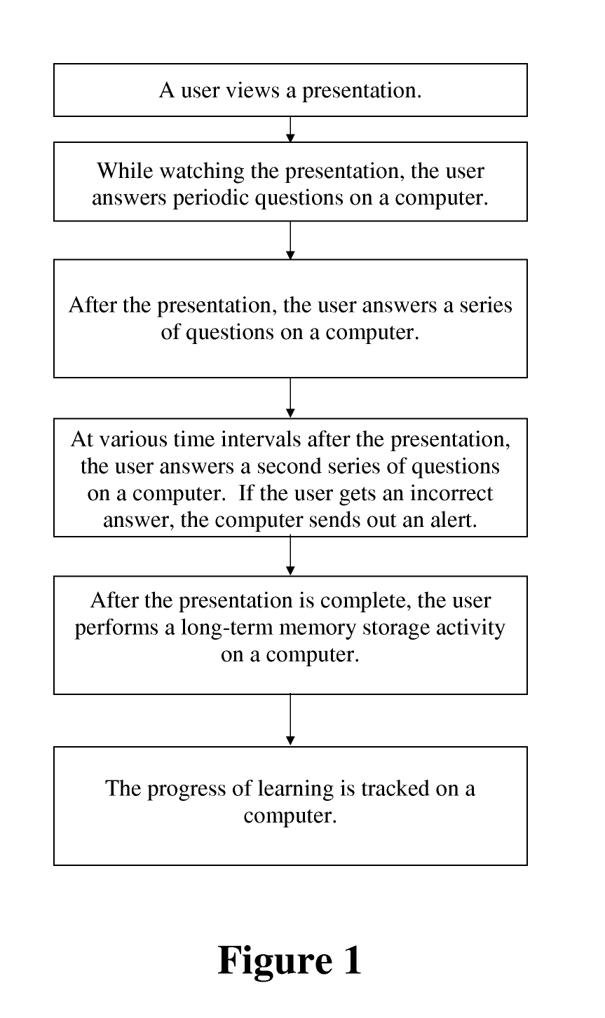

Turning now to FIG. 1, a flow chart is provided showing steps of an embodiment of the learning method. Initially a presentation is viewed by a user who is undergoing the training. While watching the presentation, the user is prompted to answer a series of periodic questions relating to the presentation. Shortly after the presentation, the user again answers a series of questions regarding the presentation. Over the course of months to years, the user may be prompted to answer a question at different time intervals to reinforce the learned material. Further, after the presentation, the user is instructed to perform a long term memory storage activity. The long term memory storage activity may include connecting with a learning community—either in person, through a telephone conference call, or online using a computer and online interface via a message board, interactive interface, chat, video chat, or social networking environment, playing a user's favorite music during the prompts and/or questions, performing additional topical research, or providing constructive feedback to the presentation providers. Finally, the progress of the training is tracked to determine the value provided by the training presentation and learning method.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A brain-based learning method comprising the steps of:
providing a presentation to a user, the presentation providing a quantity of learned information to the user;
directing the user to answer a plurality of periodic prompts using at least one computer during the viewing of the presentation, the prompts comprising a question related to the presentation;
providing a series of questions on the at least one computer for the user to answer after the completion of the presentation;
recording answers to the series of questions provided by the user;
providing a second series of questions on the at least one computer at periodic intervals after the presentation;
recording answers to the second series of questions provided by the user, wherein the system provides an alert in the event of an incorrectly answered question of the second series of questions;
directing the user to perform a long term memory storage activity using the at least one computer after the presentation, the long term memory storage activity being performed on the at least one computer; and
determining a learning progress of the user from the presentation using the at least one computer.

2. The learning method of claim 1 wherein the step of directing the user to perform a long term memory storage activity comprises the step of instructing the user to fill out a form and receiving the completed form.

3. The learning method of claim 1 wherein the step of directing the user to perform a long term memory storage activity comprises the step of using a computer for instructing the user to memorize a mnemonic phrase.

4. The learning method of claim 1 wherein the step of providing a second series of questions comprises:
receiving a plurality of email prompts, one of the plurality of email prompts being provided to the user daily using the at least one computer for one week after the presentation;
receiving answers to the plurality of email prompts using the at least one computer;
providing a second plurality of email prompts, one of the second plurality of email prompts being provided to the user monthly using the at least one computer for six months after the presentation; and
receiving answers to the second plurality of email prompts using the at least one computer.

5. The learning method of claim 1 further comprising the step of using the at least one computer to provide the user with access to an online learning community.

6. The learning method of claim 5 further comprising the step of instructing the user to provide a feedback to the online learning community using the at least one computer.

7. The learning method of claim 1 wherein the step of directing the user to perform a long term memory storage activity further comprises activating a user's favorite music using the at least one computer.

8. The learning method of claim 1 wherein the step of determining a learning progress of the user comprises the steps of:
determining a baseline metric to be tracked over the course of a training program, the baseline metric being determined before a beginning of the training, wherein the step of determining the baseline metric comprises analyzing a quantity of survey data, and analyzing a quantity of recorded productivity data;
selecting, using at least one computer, a plurality of appropriate training modules for presentation to the user based on the determined baseline metric, the appropriate training modules being graded by the at least one computer with a relevance grade;
determining an updated metric after the plurality of appropriate presentations have been presented to the user using the at least one computer; and
graphing the baseline metric and the updated metric on a graph using the at least one computer.

9. The learning method of claim 8 further comprising the steps of determining a plurality of baseline metric to be tracked over the course of a training program;
determining a plurality of updated metrics after the plurality of appropriate training modules have been presented to the trainee using the at least one computer; and
graphing the plurality of baseline metrics and the plurality of updated metrics on a single graph using the at least one computer.

10. The learning method of claim 8 further comprising the step of assigning a numerical learning requirement to the user, wherein the at least one computer tracks a status of the user's learning requirement after each of the plurality of training module presentations.

11. The learning method of claim 8 wherein the metric is a profit metric representative of organizations cash flow.

12. The learning system of claim 8 wherein the metric is a state of mind metric representative of organizational employee state of mind.

13. The learning method of claim 8 wherein the metric is a behavior metric representative of organizational employee productive behavior.

14. The learning method of claim 8 wherein the metric is an organizational/structural metric representative of optimal organizational structure.
